(19) United States
(12) Patent Application Publication
(10) Pub. No.: US 2013/0043233 A1
(43) Pub. Date: Feb. 21, 2013

(54) DEVICE FOR ACTIVE HEATING OF TRANSPARENT MATERIALS

(71) Applicants: Jeremy Alan Elser, Philadelphia, PA (US); Frederick Leonard Glick, Philadelphia, PA (US)

(72) Inventors: Jeremy Alan Elser, Philadelphia, PA (US); Frederick Leonard Glick, Philadelphia, PA (US)

(21) Appl. No.: 13/210,631

(22) Filed: Aug. 16, 2011

(51) Int. Cl. H05B 1/00; H05B 3/02

(52) U.S. Cl. 219/211; 219/200

(57) ABSTRACT

A device for removing condensate from a surface of a transparent material is disclosed. The device uses a power supply to conduct an electrical current through and thereby heat a transparent thermo-resistive element embedded within the transparent material. As the transparent thermo-resistive element is heated, heat transfers to a surface of the transparent material, thereby heating such surface to a temperature above the dew point of the condensing liquid which in turn prevents fogging on the surface of the transparent material. Embodiments of the present invention have utility in performance eyewear where fogging has the potential to reduce visibility.

### TECHNICAL FIELD

The present invention relates generally to devices for removing condensate from surfaces of transparent materials, and more specifically, to devices for removing condensate from optical surfaces of eyewear.

### BACKGROUND

The formation of condensate (i.e., fogging) on surfaces of transparent objects such as windows, eyewear and face shields has long been a challenging problem. Surface fogging acts to disperse light passing through transparent materials thereby causing objects to appear blurry and distorted when viewed through the material. This bluffing can be inhaling and potentially dangerous to the viewer. For example, fogging on automotive windows can severely obstruct a driver's view of the road and create dangerous driving conditions. Fogging on athletic eyewear such as hockey face shields, motorcycle face shields and ski goggles can be equally inhaling and dangerous and detract from the enjoyment derived from engaging in activities requiring the use of such eyewear.

Attempts have been made to eliminate or reduce the formation of condensate on optical surfaces of athletic eyewear. For example, the use of chemical surface treatments to prevent condensate formation is known in the art. However, such chemical treatments are only minimally effective for preventing fogging and must be periodically reapplied to the transparent surface as the effectiveness of such chemical surface treatments decreases over time. Other prior art systems are directed to the electrical heating of a bulky “airgap” between two solid transparent layers using a transparent thermo-resistive film. See U.S. Pat. No. 5,351,339 (Rueber et al.); U.S. Pat. No. 5,694,650 (Hong); U.S. patent application Ser. No. 10/769,979 (Douglas). However, these cumbersome and heavy airgap systems are not suitable for use in performance sports such as hockey, lacrosse or American football and have thus been relegated primarily to motor sports applications where quick head movements are not generally required.

Other prior art systems are directed to the use of transparent thermo-resistive coatings, such as Indium Tin Oxide (ITO), which are distributed over the entire surface of a transparent material. See U.S. Pat. No. 4,584,721 (Yamamoto); U.S. Pat. No. 5,471,036 (Sperbeck). The inherent resistive properties of such thermo-resistive coatings causes the coatings to heat up when an electrical current is passed through them. In this way, the coating heats the surface of the transparent material thereby preventing the accumulation of condensation.

Yamamoto discloses the use of such distributed thermo-resistive coatings in connection with conductive “busbars” that must circumscribe the thermo-resistive coating to adequately distribute voltage levels through the entire thermo-resistive coating. Such busbars are typically made from conductive metals such as copper or silver which can be visually obstructive. Furthermore, systems such as that disclosed in Yamamoto incorporate the thermo-resistive element into a removable patch structure, which effectively doubles the thickness of the face shield and yet cannot be considered a general-purpose attachment as dissimilar helmets and eye glasses would likely have different curvature than the proposed attachment.

Sperbeck discloses the use of ITO coatings in connection with goggles. Like Yamamoto, Sperbeck teaches the use of conductive busbars to deliver an electrical current to an ITO layer thereby heating the goggle surface. However, such conductive busbars may also be visually obstructive and add to the cost of the device. In addition, the ITO surface coatings of the prior art systems are more susceptible to scratching and other types of damage making them less than ideal for use in contact sports such as hockey, lacrosse and American football. Further, the relatively large surface area of distributed ITO coatings requires greater electrical current in order to heat the surface. This increased electrical usage requires larger power supplies that add bulk and weight to the system. In fact, some prior art systems require the use of external battery packs which are inappropriate for performance sports where speed and agility are required. Additionally, the requirement to use busbars does not allow distributed coatings to be selectively applied to surface regions of the eyewear where condensation is most likely to form such as those adjacent to a wearer's mouth and nose.

### SUMMARY OF THE INVENTION

The above-described problems are addressed and a technical solution is achieved in the art by the active heating devices described herein. According to one or more embodiments of the present invention, a device for evaporating condensate from a surface is described which comprises a transparent base; a transparent thermo-resistive element having at least one positive electrode and at least one negative electrode, wherein the transparent thermo-resistive element is embedded within the transparent base; and a power supply configured to conduct an electrical current through the transparent thermo-resistive element to heat a surface of the transparent base to a temperature greater than a dew point of the condensate. In some embodiments, the transparent base comprises a single layer of material that may be made of a glass material or a polymeric material.

In another embodiment, a defogging device for evaporating condensate from a surface of eyewear is described which comprises a protective helmet; a transparent face shield engaged to the helmet; a transparent thermo-resistive element having at least one positive electrode and at least one negative electrode, wherein the transparent thermo-resistive element is embedded within the transparent face mask; and an onboard power supply configured to conduct an electrical current through the transparent thermo-resistive element and heat a surface of the transparent face mask to a temperature greater than a dew point of the condensate.

In another embodiment, a defogging device for evaporating condensate from a surface of eyewear is described which comprises at least one transparent lens; a transparent thermo-resistive element having at least one positive electrode and at least one negative electrode wherein the transparent thermo-resistive element is embedded within the at least one transparent lens; and an onboard power supply configured to conduct an electrical current through the transparent thermo-resistive element and heat a surface of the transparent lens to a temperature greater than a dew point of the condensate.

### BRIEF DESCRIPTION OF THE DRAWINGS

The present invention will be more readily understood from the detailed description of exemplary embodiments presented below considered in conjunction with the attached drawings, of which:

FIG. 1 is a schematic view of a device for evaporating a condensate, according to an embodiment of the present invention;

FIG. 2 is a schematic view of a device for evaporating a condensate, according to an embodiment of the present invention;

FIG. 3 is a schematic view of a device for evaporating a condensate, according to an embodiment of the present invention;

FIG. 4 is a schematic view of a device for evaporating a condensate, according to an embodiment of the present invention;

FIG. 5 is a schematic view of a device for evaporating a condensate, according to an embodiment of the present invention; and

FIG. 6 is a perspective view of a helmet and face shield device for evaporating a condensate, according to an embodiment of the present invention.

It is to be understood that the attached drawings are for purposes of illustrating the concepts of the invention and may not be to scale, and are not intended to be limiting in terms of the range of possible shapes and/or proportions. Like reference numerals refer to corresponding parts throughout the several views of the drawings.

### DETAILED DESCRIPTION OF THE INVENTION

Embodiments of the present invention relate to devices for evaporating condensate from a surface of transparent base material. In one embodiment, a thermo-resistive element for heating the surface is made more scratch-resistant by embedding the thermo-resistive element directly into the transparent base. In another embodiment, a thermo-resistive element may be configured in such a way as to reduce the amount of electricity required to heat the element thereby reducing the size of any required external power source. In another embodiment, a thermo-resistive element may be configured in such a way as to selectively heat particular areas of the eyewear surface that are susceptible to condensation accumulation, namely near a wearer's nose and mouth.

Embodiments of the present invention relate to a device for heating a surface of a transparent base used in eyewear thereby preventing the accumulation of condensing fluids, generally water. The device comprises a transparent base which may be a face shield such as that typically found on athletic equipment (e.g., hockey, lacrosse, baseball and American football helmets) and one or more lenses (e.g., ski goggles and glasses). Surface heating is achieved by embedding a transparent thermo-resistive element directly into the transparent base and applying an electrical current to the thermo-resistive element using a power supply connected to corresponding positive and negative electrodes of the thermo-resistive element.

For purposes of this specification, terms are to be given in their plain and ordinary meaning in the context in which they arise as understood by those possessing ordinary skill in the art. To avoid any ambiguity, however, several terms are described herein. The term “base material” or “base” as used herein is intended to include, but is not limited to, any material (translucent or otherwise), the surface of which may be susceptible to the collection of liquid condensation. The term “busbar” as used herein is intended to include, but is not limited to, any conductive material linked to an electrical terminal to create a physically extended region at which the voltage is identical to the terminal. The term “thermo-resistive element” as used herein is intended to include, but is not limited to, any material exhibiting properties of electrical resistivity such that a temperature increase in the material occurs upon passing an electrical current through the material. The term “filament” as used herein is intended to include, but is not limited to, any thread-like object having a generally rectangular, circular or oblong cross-section, such cross-section being of any suitable diameter or width depending on the intended application. As used herein, the term “engage” is intended to include, but is not limited to, any suitable means or method to mount, attach, connect, integrally connect, affix, join, adhere, etc.

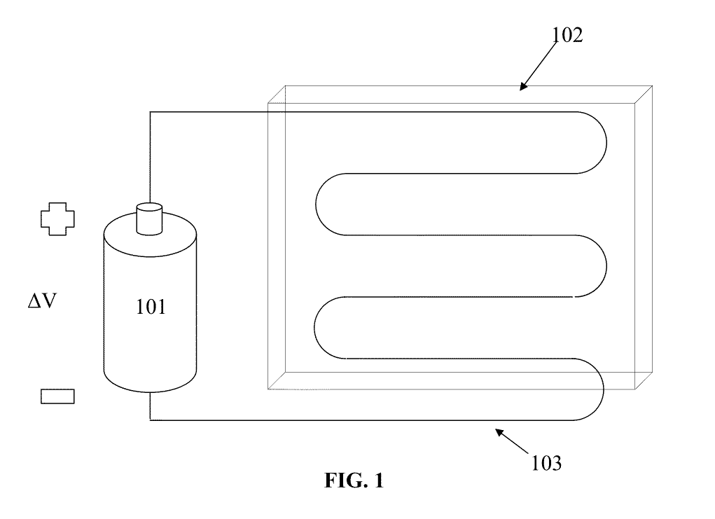

Referring to FIG. 1, a device according to an embodiment of the present invention includes a power supply 101, a transparent base 102 and a transparent thermo-resistive element 103 embedded within the transparent base 102. The positive and negative terminals of the power supply 101 are connected to corresponding positive and negative electrodes of the thermo-resistive element 103 so as to create a voltage gradient across the thermo-resistive element. Such voltage gradient causes an electrical current to pass through the thermo-resistive element 103, thereby causing the temperature of the thermo-resistive element 103 to rise. As the temperature of the thermo-resistive element 103 rises, heat transfers from the transparent thermo-resistive element 103 into the transparent base 102, causing the surface temperature of the transparent base 102 to also rise. As the surface temperature of the transparent base 102 increases above the prevailing ambient dew point, any liquid condensed on the transparent base 102 evaporates thus defogging the surface. Embodiments of the present invention are generally directed to situations where the condensate is water, however one having ordinary skill in the art will appreciate that embodiments of the present invention have application to a variety of situations where condensation causes fogging on surfaces of transparent material.

According to an embodiment of the present invention, the power supply 101 may be a stored energy source (e.g., a battery) or a generating source (e.g., a photovoltaic cell or heat-transfer device, which may operate by taking advantage of the heat gradient between the wearer's body and environmental surrounding). One having ordinary skill in the art will appreciate that a wide variety of power supplies may be used. In addition, one having ordinary skill in the art will appreciate that additional components such as voltage regulators and thermostats may be used in conjunction with the power supply 101 to regulate and/or automate the flow of electrical current.

According to an embodiment of the present invention, the transparent base 102 may comprise any suitable material such as plastic, glass or a composite. The shape and thickness of the transparent base 102 may vary depending on the intended application. In one embodiment, the transparent base 102 may comprise a plastic face shield for use with personal protective equipment such as that found on athletic headgear (e.g., hockey helmets, American football helmets, motorcycle helmets) and industrial headgear (e.g., welding masks, chemical splash guards). In another embodiment, the transparent base 102 may comprise a single lens such as that found in activities such as skiing, scuba diving and sky diving. In another embodiment, the transparent base 102 may comprise a double lens for use in applications such as corrective and non-corrective eyeglasses and sunglasses and swimming goggles. One having ordinary skill in the art will appreciate the wide variety of shapes and sizes the transparent base 102 may take on.

According to an embodiment of the present invention, the transparent thermo-resistive element 103 comprises a suitable transparent material, such as, for example, Indium-Tin-Oxide (ITO) and related formulations. One having ordinary skill in the art will appreciate that other materials may make suitable thermo-resistive elements. The transparent thermo-resistive element 103 is a long filamentous strip arranged in a curvilinear geometry relative to the transparent base 102 but one having ordinary skill in the art will appreciate that a wide variety of shapes and configurations other than those described herein may be used based on the intended application. While the transparent thermo-resistive elements in the several drawings have been shown as black lines for purposes of illustration, such thermo-resistive elements are substantially transparent in actual embodiments.

Embodiments of the present invention allow for the use of transparent thermo-resistive elements 103 such as ITO which require only two (2) electrodes (positive and negative). This and other geometries described herein are advantageous because they eliminate the need for busbars such as those typically used for ITO films and coverings. The thermo-resistive element geometries disclosed herein also offer advantages over prior art geometries because less electricity is required to heat the surface of the transparent base 102. Distributing the transparent thermo-resistive element 103 within the transparent base 102 takes advantage of heat transfer properties of the transparent base 102 thus requiring the use of smaller thermo-resistive elements while still maintaining adequate heating capability. Embedding the transparent thermo-resistive element 103 within the transparent base 102 also has the added advantage of protecting the transparent thermo-resistive element 103 from damage. Embodiments of the present invention are therefore ideal for contact sports as damage to the transparent thermo-resistive element 103 could hinder its operation and efficiency.

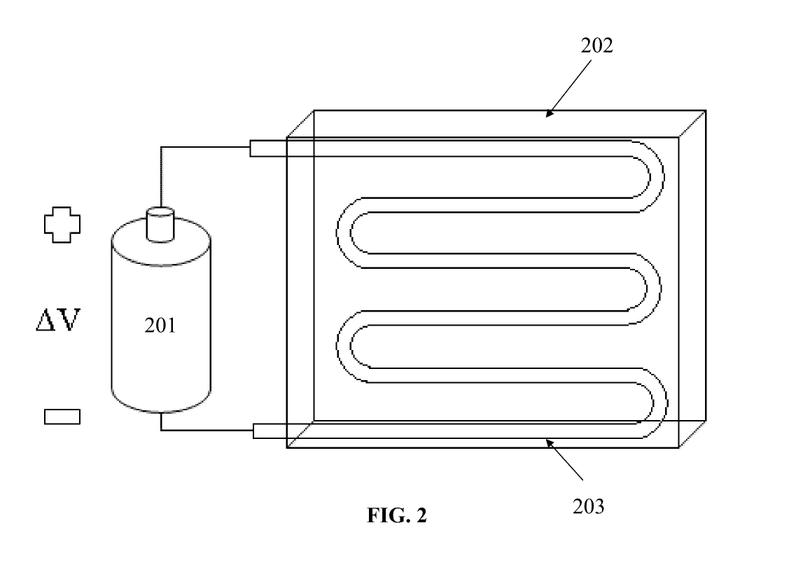

Referring to FIG. 2, a device according to an embodiment of the present invention includes a power supply 201, a transparent base 202 and a transparent thermo-resistive element 203 embedded within the transparent base 202. The transparent thermo-resistive element 203 shown in FIG. 2 comprises a larger diameter wire-type structure than the thinner filamentous structure shown in FIG. 1. In general, larger transparent thermo-resistive elements result in greater heat transfer to the transparent base 202 but also require more energy to heat. One having ordinary skill in the art will appreciate that the exact geometry of the thermo-resistive element can be chosen to so as to maximize heating potential and heat transfer while minimizing power consumption.

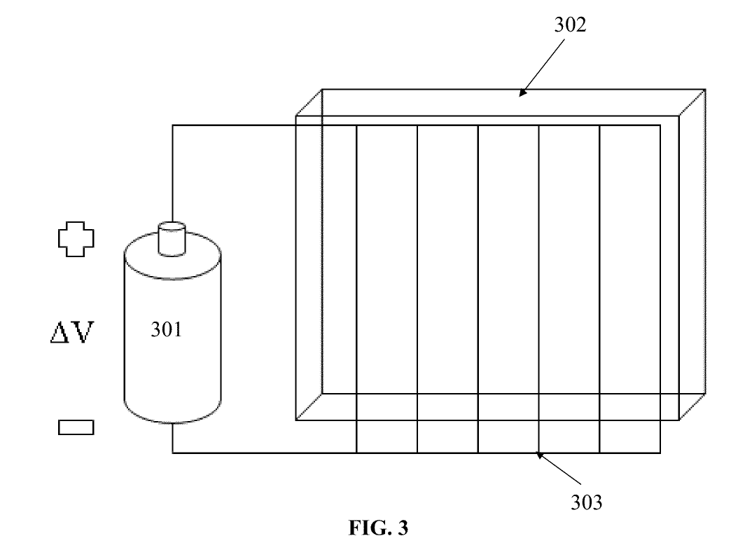

Referring to FIG. 3, a device according to an embodiment of the present invention includes a power supply 301, a transparent base 302 and a transparent thermo-resistive element 303 embedded within the transparent base 302. The transparent thermo-resistive element 303 is configured using a filamentous structure arranged in a grid pattern with multiple electrical paths between the power supply 301. Arranging the transparent thermo-resistive element 303 in a grid pattern results in a non-uniform heating profile as a function of time. The sections of the thermo-resistive element 303 that are closer to the terminals of the power supply 301 will heat up faster than those further from the power supply 301. Thermo-resistive element geometries like that shown in FIG. 3 can therefore be configured to quickly heat regions of the transparent base 302 that are particularly susceptible to condensation (such as regions of a face shield near the user's mouth and nose).

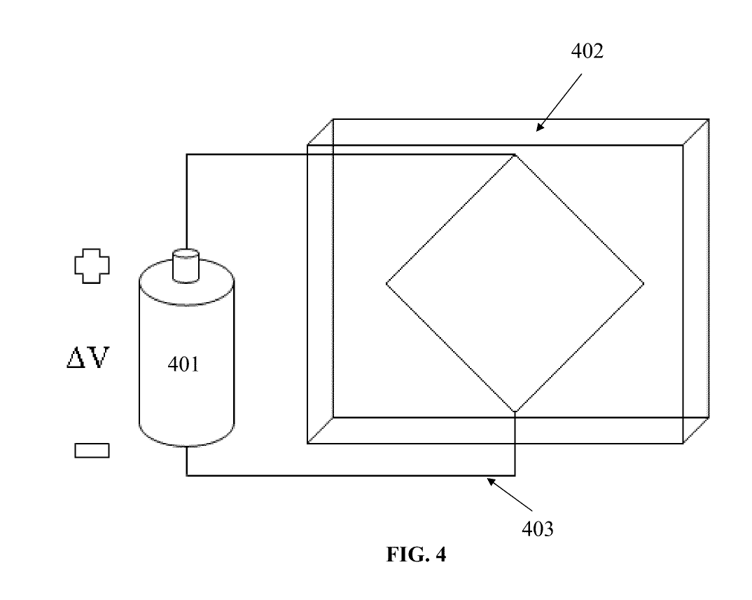

Referring to FIG. 4, a device according to an embodiment of the present invention includes a power supply 401, a transparent base 402 and a transparent thermo-resistive element 403 embedded within the transparent base 402. The transparent thermo-resistive element 403 is configured using a filamentous structure arranged in a branching pattern. One or more branch points can be used to distribute heat non-uniformly over the base material. One having ordinary skill in the art will appreciate that by altering the path lengths (and subsequently, the path electrical resistance) the heating pattern of the transparent thermo-resistive element 403 can be controlled to preferentially cause certain regions of the transparent base 402 to heat faster than other regions.

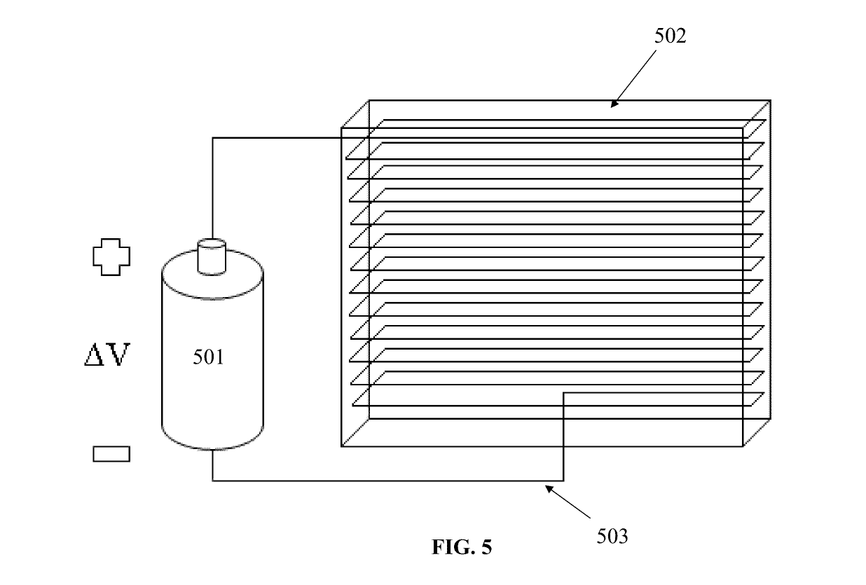

Referring to FIG. 5, a device according to an embodiment of the present invention includes a power supply 501, a transparent base 502 and a transparent thermo-resistive element 503 embedded within the transparent base 502. The transparent thermo-resistive element 503 is configured using a filamentous structure arranged in a rectangular pattern. In this embodiment, the thermo-resistive element 503 is arranged to take advantage of all three (3) dimensions of the transparent base 502. Such a geometry can be used to supply additional heat to high priority areas in the transparent base 502 such as those near wearer's mouth and nose.

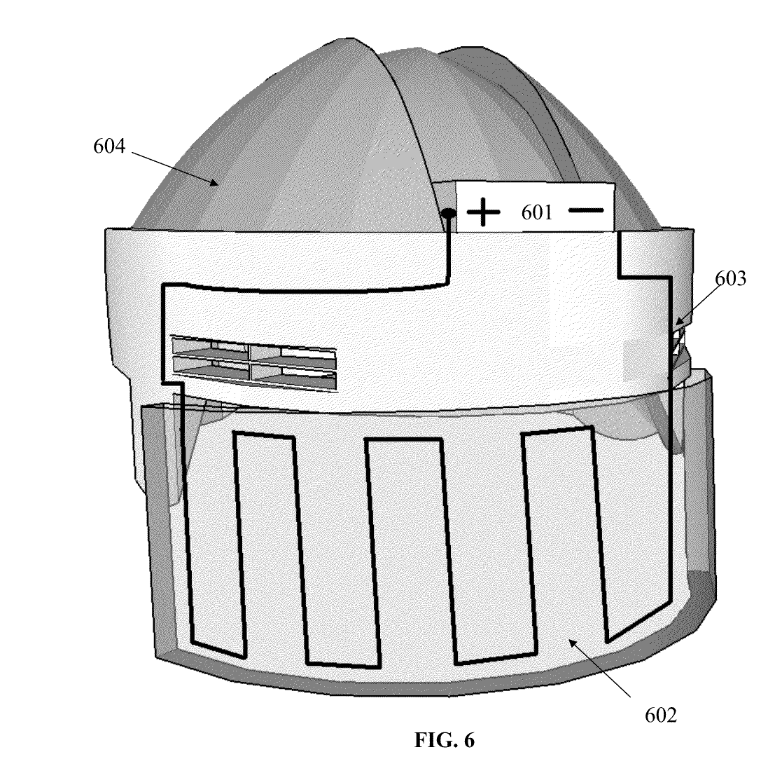

Referring to FIG. 6, a hockey helmet according to an embodiment of the present invention includes a protective helmet 604, power supply 601, a transparent face shield 602 engaged to the protective helmet 604 and a transparent resistive element 603 embedded within the transparent face shield 602. The power supply 601 comprises an on-board battery compartment engaged to the helmet 604. The location of the power supply 601 may be chosen so as to limit potential damage to the power supply 601 or so as not to restrict the wearer's view. One having ordinary skill in the art will appreciate that the number and type of batteries that may be used in the power supply will vary depending on the particular application. The transparent thermo-resistive element 603 is configured using a filamentous structure arranged in a curvilinear pattern. However, as described in other embodiments, the transparent thermo-resistive element 603 may be arranged so as to heat those portions of the face shield 602 that are closer to a wearer's mouth and nose.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A device for evaporating condensate comprising:
a transparent base;
a transparent thermo-resistive element having at least one positive electrode and at least one negative electrode, wherein the transparent thermo-resistive element is embedded within the transparent base; and
a power supply configured to conduct an electrical current through the transparent thermo-resistive element to heat a surface of the transparent base to a temperature greater than a dew point of the condensate.

2. The device of claim 1, wherein the transparent base comprises a single layer.

3. The device of claim 1, wherein the transparent base comprises a polymeric material.

4. The device of claim 1, wherein the transparent base comprises a glass material.

5. The device of claim 1, wherein the transparent base comprises a face shield.

6. The device of claim 5, wherein the transparent thermo-resistive element is arranged proximal to a wearer's mouth and nose when the face shield is worn.

7. The device of claim 1, wherein the transparent base comprises at least one lens.

8. The device of claim 1, wherein the power supply comprises a battery.

9. The device of claim 1, wherein the power supply comprises a photovoltaic cell.

10. The device of claim 1, wherein the transparent thermo-resistive element is indium-tin-oxide.

11. The device of claim 1, wherein the transparent thermo-resistive element comprises a filamentous strip.

12. The device of claim 11, wherein the transparent thermo-resistive element is arranged in a curvilinear pattern.

13. The device of claim 11, wherein the transparent thermo-resistive element is arranged in a mesh pattern.

14. The device of claim 11, wherein the transparent thermo-resistive element is arranged in a branched pattern.

15. A defogging device for evaporating condensate from a surface of eyewear, the device comprising:
a protective helmet;
a transparent face shield engaged to the helmet;
a transparent thermo-resistive element having at least one positive electrode and at least one negative electrode, wherein the transparent thermo-resistive element is embedded within the transparent face mask; and
a power supply engaged to the protective helmet configured to conduct an electrical current through the transparent thermo-resistive element and heat a surface of the transparent face mask to a temperature greater than a dew point of the condensate.

16. The defogging device of claim 15, wherein the transparent face shield comprises a polymeric material.

17. The defogging device of claim 15, wherein the thermo-resistive element comprises a filamentous strip arranged in a curvilinear pattern.

18. The defogging device of claim 17, wherein the transparent thermo-resistive element is arranged proximal to a wearer's mouth and nose when the protective helmet is worn.

19. The defogging device of claim 15, wherein the protective helmet is a hockey helmet.

20. The defogging device of claim 15, wherein the protective helmet is a football helmet.

21. A defogging device for evaporating condensate from a surface of eyewear, the device comprising:
at least one transparent lens;
a transparent thermo-resistive element having at least one positive electrode and at least one negative electrode, wherein the transparent thermo-resistive element is embedded within the at least one transparent lens; and
a power supply configured to conduct an electrical current through the transparent thermo-resistive element and heat a surface of the transparent lens to a temperature greater than a dew point of the condensate.

22. The defogging device of claim 21, wherein the thermo-resistive element comprises a filamentous strip arranged in a curvilinear pattern.
